(19) United States
(12) Patent Application Publication
(10) Pub. No.: US 2007/0055037 A1
(43) Pub. Date: Mar. 8, 2007

(54) Isocyanate-based compositions, use thereof for making coatings, especially adhesives, and aliphatic adhesive joints thus obtained

(76) Inventors: Vincent Grainer, Vernaison (FR); Corinne Varron, Lyon (FR)

Correspondence Address: Jean-Louis Seugnet;Rhodia Inc, 259 Prospect Plains Road, CN 7500, Cranbury, NJ, 08512, US

(21) Appl. No.: 10/552,521

(22) PCT Filed: Apr. 8, 2004
(86) PCT No.: PCT/FR04/00873

§ 371 Date: Oct. 7, 2005

(30) Foreign Application Priority Data
Apr. 8, 2003 (FR) 03 04342

(51) Int. Cl. C08G 18/00

(52) U.S. Cl. 528/44

(57) ABSTRACT

The invention relates to the use of an emulsifiable isocyanate composition in adhesives. The composition comprises an isocyanate composition, with a mass content of N═C═O functions of 10% to 30% and a viscosity of at most 1,500 mPa·s., a detergent agent, with a principal component of a compound or a mixture of compounds of general formula: R; 20-(CH; 2-CH; 2-O); s-CH; 2-CH; 2-X′; q-P(═O); m(O; -); p-X—CH; 2-CH; 2(-O—CH; 2-CH; 2); n-O—R; 1, where p=between 1 and 2 (closed intervals, in other words inclusive limits),m=0 or 1, where p+m+q=max. 3, 1+p+2m+q=5, X and X′═O or a simple bond, n and s independently=5 to 25, R; land R; =independently or preferably the same aliphatic group not having an aromatic nucleus. The above is of application to the adhesive industry.

The present invention relates to compounds and compositions based on isocyanates (which may be partially or even totally masked, but this is not the preferred embodiment). The invention is also directed toward the process for using them to make coatings and their use for making adhesives and especially adhesive joints thus obtained. The invention more particularly relates to compositions that are (self-)dispersible in aqueous phase, especially for coating and especially bonding wood and elastomer.

To understand the invention more clearly, it would appear appropriate to recall the following.

In the present description, the particle size characteristics often refer to notations of the type dₙ in which n is a number from 1 to 99; this notation is well known in many technical fields, but is rather more rare in chemistry, and it may thus be worthwhile recalling its meaning. This notation represents the particle size such that n % (by weight, or more exactly by mass, since the weight is not an amount of material but a force) of the particles is less than or equal to said size.

In the rest of the description, the polydispersity index will be used, which is defined as:
I=(d₉₀−d₁₀)/d₅₀

Until very recently, the vast majority of isocyanates were essentially dissolved in organic solvents. The use of organic solvents is increasingly coming under criticism by the authorities in charge of safety at work, since these solvents, or at least some of them, are notoriously toxic or chronotoxic. This is why attempts are increasingly made to develop techniques that contain little solvent, or even that are solvent-free. In particular, to overcome the drawbacks related with solvents, complex compositions are sought, occasionally referred to as systems, which can replace mixtures in solvent medium.

In particular, to reduce the use of organic solvent, the presence of which is well known as being toxic to those handling it and harmful to the environment, it has been proposed to develop isocyanate compositions that are both readily emulsifiable and readily usable as an emulsion in water. In this case, the water serves as a “vehicle” for the components of the formulation and makes it possible to reduce, or even dispense with, the organic solvents required especially for adjusting the viscosity.

As regards the isocyanates, the ones most commonly used are the diisocyanates, especially the alkylene diisocyanates (for example those sold under the brand name Tolonate®) especially in the form of oligomeric derivatives thereof, such as those containing a biuret unit, those containing a uretidinedione unit, those containing unit(s) derived from various trimerizations or capable of being derived therefrom. The various units or rings that may be formed during trimerization may be recalled:

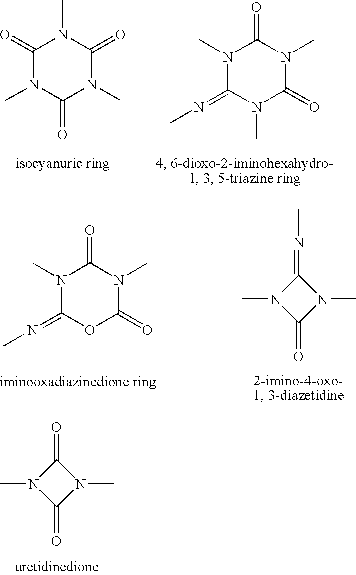

Although the present invention can be used in fields other than that of coating (especially adhesives, paints and varnishes), in the rest of the description its application in paints and varnishes will be used to more clearly explain the problem and to serve, where appropriate, as a typical example.

In order to understand the scope of the invention more clearly especially in the field of paints and varnishes, it is worthwhile recalling a little the techniques and systems used to reduce or dispense with the use of organic solvent.

Thus, to make films of paints or varnishes, a dispersion or an emulsion containing the isocyanate, on the one hand, and a dispersion or a solution of di- or polyfunctional coreagent (of function bearing reactive hydrogen, see below), generally polyols, on the other hand, are mixed together. Given the reactivity of the free isocyanate function, the isocyanates are usually masked. When such is not the case, the free isocyanates are usually placed in emulsion directly in the dispersion of coreagent.

The pigments and the various fillers and additives are usually present or introduced into the aqueous phase bearing the coreagent (generally polyol) before introduction of the isocyanate; however, they may be introduced after the formation of the double dispersion.

The isocyanate may be free or masked and, in the latter case, totally or partially masked. The present invention is especially directed toward the case where at least some of the isocyanate functions are unmasked.

A related aim of the present invention is to facilitate the dispersion of the optional pigments and fillers, and especially of titanium dioxide.

Once the final dispersion is complete, it is then spread onto a support in the form of a film using standard techniques for using industrial coatings, especially paints and varnishes.

When the preparation contains masked isocyanates, the film+support assembly is baked at a temperature sufficient to ensure the release of the isocyanate functions and/or the condensation thereof with compounds having functions containing reactive hydrogen which are well known to those skilled in the art (amine, sulfhydryl, alcohol, in other words hydroxyl functions), in general hydroxyl function, of the coreagent. It should be recalled, however, that the masked or blocked products have a significantly higher cost price than unmasked products.

Thus, one of the solutions most commonly proposed lies in the use of dispersions, especially emulsions, in water. On account of the reactivity of water with isocyanates, this solution is especially used for masked isocyanates.

Needless to say, these problems must be resolved while respecting the constraints intrinsic to coatings.

For example, in order not to jump out of the frying pan into the fire, a major hazard must be avoided, i.e. that of deteriorating one or more of the essential qualities of coatings (for paints and varnishes, maintaining the smooth nature and avoiding the “orange peel” defect, the hardness, the resistance to solvents, the adhesion to any support, etc.).

In particular, poor adhesion of the coating to its support should be feared. The reason for this is that many surfactants are notorious for impairing the strength of the bond between the coating and its support and are known and used to undermine the attachment between a polymer and a support. Such phenomena are described especially in DE-A 3 108 537.

Usually, when unmasked or incompletely masked isocyanates are used, in the form of an aqueous emulsion, the time for which they may be used remains less than a few hours, generally one or two hours. It is important that the use of novel emulsifiers should not be reflected by a significantly reduced service life.

Thus, it is important not to encounter any difficulties during the dispersing operation, especially of isocyanates in emulsion.

The regulations in various countries and especially in those of the European Community are in the process of banning the synthons that are the most commonly used and the most efficient in surfactants, namely aromatic derivatives. Among the latter derivatives are especially targeted those comprising radicals known as “nonylphenyl” radicals and more particularly the derivatives obtained by the nonylphenol-initiated condensation of epoxides or alkene oxides.

To use an understatement, it may be said that the development of replacement solutions is not a piece of cake.

As more specifically regards the use for adhesives, a few elements of this technique should be recalled in order to understand the invention more clearly. As for other coatings, solvents have been used widely for a long time in the adhesives industry, but the use of organic solvents is coming under increasing criticism by the authorities in charge of safety at work, since the solvents, or at least some of them, are notoriously toxic or chronotoxic.

This is one of the reasons for which attempts are increasingly being made to develop techniques that replace the techniques in solvent medium to overcome the drawbacks associated with solvents.

To reduce the use of organic solvent, the presence of which is known to be toxic to those handling it and harmful to the environment, it has been proposed to develop aqueous-phase adhesives.

The vast majority of adhesives of this type consist of polymer(s), usually in the form of a dispersion, in an aqueous phase whose evaporation brings about the bonding.

However, it is seen that the adherence properties of the adhesive joints obtained with this kind of adhesive could be significantly enhanced by the presence of isocyanate dispersed in said aqueous phase. The mechanism of this potentialization is not fully elucidated.

Thus modified, these dispersions constitute a novel class of adhesive, and are formed from a dual dispersion in the same aqueous phase of polymer(s) (soluble or, usually, in dispersion) on the one hand, and of dispersed isocyanate on the other hand.

In general, this mixed dispersion is obtained either by mixing the polymer-vector aqueous phase with an isocyanate emulsion; or by direct emulsification of the isocyanate in the aqueous phase bearing the polymer.

It is the latter technique that is the most desired.

Despite the advantage of this technique, there are few choices in the range of isocyanate-based compositions suitable for this use, since they need to satisfy a variety of constraints and the choice of emulsifiers is critical.

Thus, the technique for emulsifying the isocyanate composition needs to be compatible with the polymer-vector medium in order to avoid on the one hand a reduction in the time during which the dispersion may be used for bonding, and on the other hand demixing with possible phase separation. This implies both physical stability of the dispersions and also a certain level of chemical stability.

The reason for this is that, usually, when unmasked or incompletely masked isocyanates are used, in the form of an aqueous emulsion, the time for which they can be used remains less than a few hours, in general one or two hours. It is important to ensure that the use of novel emulsifiers is not reflected by a shorter service life.

The problem is all the more difficult since the diversity of adhesive polymers used is wide and since their characteristics depend on the material whose surface is to be bonded.

Finally, it often arises that the adhesive joints obtained with adhesive in aqueous phase, and especially in dispersion, show reduced adherence in a humid environment.

In addition, many surfactants are well known to impair the strength of the bond between the coating and its support. As a result, they are known and used to undermine the attachment between a polymer and a support.

This is why one of the aims of the present invention is to provide an isocyanate composition that can be readily emulsified under a wide range of conditions.

Another aim of the present invention is to provide an isocyanate composition that can be readily emulsified under a wide range of conditions without using emulsifiers containing an aromatic nucleus.

Another aim of the present invention is to provide an isocyanate composition that overcomes the problems of adherence in a humid environment.

Another aim of the present invention is to provide an isocyanate composition that facilitates adhesion and gives a coating (paint, varnish, etc.) that shows good adherence to organic supports, especially to (co)polymers of vinyl nature (such as acrylic, isoprene and/or styrene (co)polymers).

Another aim of the present invention is to provide an isocyanate composition that gives a coating (paint, varnish, etc.) which shows good adherence to elastomeric organic supports such as synthetic or natural rubber.

Another aim of the present invention is to provide an isocyanate composition that gives a coating that shows good adherence to supports of biological origin, especially wood.

Another aim of the present invention is to provide an isocyanate composition that gives a paint, and especially a varnish, of quality that shows good quality and especially good adherence to supports directly of biological origin, such as wood, or which have undergone a prior transformation, such as particle boards, plywoods, paper and natural rubbers.

Another aim of the present invention is to provide a adhesive joint joining together at least two surfaces, at least one of which is of biological origin.

Another aim of the present invention is to provide a adhesive joint joining together at least two surfaces, at least one of which is that of an organic support material, especially those of (co)polymers of vinyl nature (such as acrylic, isoprene and/or styrene (co)polymers).

These aims, and others that will become apparent hereinbelow, are achieved by means of using in the adhesives an emulsifiable isocyanate composition comprising:
an isocyanate composition a) with a mass content of N═C═O function of between 10% and 30% (limits inclusive) and advantageously from 15% to 25% (limits inclusive) and with a viscosity of not more than 2500 mPa·s, advantageously not more than 1500 mPa·s, preferably not more than 1400 mPa·s and more preferentially not more than 1200 mPa·s;
a surfactant comprising as main constituent a compound or a mixture of compounds of general formula (I):

in which: 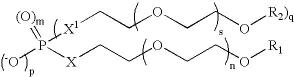
p represents an integer between 1 and 2 (closed intervals, i.e. including the limits);
m represents zero or, advantageously, 1;
the sum p+m+q is not more than 3;
the sum 1+p+2m+q is equal to 3 or 5, advantageously 5;
X is an oxygen or a single bond;
X′ is an oxygen or a single bond;
n and s, which may be identical or different, represent an integer chosen from those at least equal to 2, advantageously to 3, preferably to 4 and more preferentially to 5, and not more than 30, advantageously not more than 25, preferably not more than 20 and more preferentially not more than 9; thus, the preferred intervals are between 3 and 25, advantageously between 5 and 20 and preferably between 5 and 9 (closed intervals, i.e. including the limits);
in which R₁ and R₂, which are different or, advantageously, identical, are chosen from radicals of aliphatic nature (i.e. their open bond is borne by a carbon of sp³ hybridization of 8 to 20 carbon atoms) and with no aromatic nucleus, optionally substituted, advantageously alkyls, excluding aralkyls.

R₁ and R₂ usually represent an alkyl, optionally and advantageously a branched alkyl of 8 to 20 carbon atoms. It is often an alkyl mixture derived from mixtures of alcohols (in general a mixture of isomers) such as the product sold under the name isotridecyl alcohol.

The integer q thus represents one or zero.

For s and n, a choice in the interval ranging from 9 to 20 may also be advantageous when the cocations are highly soluble (optionally sequestered alkali metals, quaternary ammoniums or phosphoniums, tertiary amines of low molecular weight, i.e. of not more than 7 carbon atoms), advantageously one from among X and X′ is oxygen, and preferably both are oxygen.

It is preferable that, in the case of a mixture of compounds of formula (I), the majority of them on a molar basis corresponds to formula (I) with “q” being zero to give formula (II):

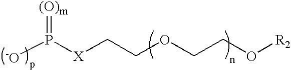

with:
“m” being equal to zero or 1, preferably 1, and
“p” being 2.

When a mixture of compounds is used, as is preferred, the values, which are integers for a defined molecule, become values that may then be fractional.

Thus, in formula (I), q, p (or even m, but this is not preferred on account of the difficulty of synthesis, products of two different syntheses needing to be mixed together: phosphite and phosphate) and especially n and s become statistical values (on a numerical basis, although this makes hardly any difference, the number of molecules of formula (I) then possibly being readily determined by pH-metry, see below).

The statistical ratio of diester to monoester (i.e. q) is advantageously not more than ¾, advantageously not more than ⅔, preferably not more than ½, and even less (see below).

The emulsifiable composition then becomes an emulsifiable isocyanate composition advantageously comprising:
an isocyanate composition with a mass content of N═C═O function of between 15% and 25%, and with a viscosity of not more than 2500 mPa·s, advantageously not more than 1500 mPa·s, preferably not more than 1400 mPa·s and preferentially 1200 mPa·s; a surfactant comprising as main constituent a compound or a mixture of compounds of mean general formula: 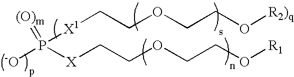
in which:
p represents a value between 1 and 2 (closed intervals, i.e. including the limits);
m represents 0 or 1, advantageously 1;
the sum p+m+q is equal to 3;
the sum 1+p+2m+q is equal to the valency of the phosphorus, i.e. to 3 or 5, advantageously 5;
X is an oxygen;
X′ is an oxygen;
n and s advantageously have the same statistical value; n and s, which may be identical or different, represent a statistical value chosen from those at least equal to 2, advantageously to 3, preferably to 4 and more preferentially to 5, and not more than 30, advantageously not more than 25, preferably not more than 20 and more preferentially not more than 9; thus, the preferred intervals are between 3 and 25, advantageously between 5 and 20 and preferably between 5 and 9 (closed intervals, i.e. including the limits);
in which R₁ and R₂, which are different or, advantageously, identical, are chosen from radicals of aliphatic nature with no aromatic nucleus, optionally substituted, advantageously alkyls.

The value q represents a value chosen in the closed interval ranging from 0 to 1.

For s and n, a choice in the interval ranging from 9 to 20 may also be advantageous when the cocations are highly soluble (optionally sequestered alkali metals, quaternary ammoniums or phosphoniums, tertiary amines of low molecular weight, i.e. of not more than 7 carbon atoms); alkyl is taken in its etymological sense as an alcohol from which an OH function has been removed. R₁ and R₂ usually represent an alkyl, which is optionally and advantageously branched, ranging from 8 to 20 carbon atoms (integer or statistical value), preferably from 10 to 15 carbon atoms, more preferentially comprising only hydrogen and carbon. It is desirable for R₁ and even R₂ to be alkyl within the IUPAC meaning, i.e. corresponding to an alkane, optionally a cyclic alkane, from which a hydrogen has been removed.

It should be noted that the statistical ratio “q”, which is chosen in the closed interval ranging from 0 to 1, is readily determined by acid-base titration.

It is then desirable for the statistical “q” to be not more than 0.5, advantageously not more than 0.3 and preferably not more than 0.2.

In this case, the mean formula is a numerical mean (total number of units or atoms of each type divided by the number of molecules), the proportions of each molecule being measured by liquid chromatography and, where appropriate, by gel permeation for the heavy molecules.

These compounds may be obtained by partial esterification of phosphorus acids, advantageously phosphoric acids, with polyethylene oxides (of s and n units) ending with an alcohol function and starting with an alcohol (R₁ and/or R₂).

The mass ratio between, on the one hand, said compounds of formula (I) (numerator) and, on the other hand, the isocyanates to be suspended, is usually not more than about 0.1 and advantageously not more than about 0.10. In the present description, the term “about” is used solely to emphasize the fact that the given values correspond to a mathematical round-up and that when the figure(s) the furthest to the right of a number are zeros, these zeros are positional zeros rather than significant figures, unless, of course, otherwise specified.

The mass ratio between the compounds of formula (I) (numerator) and the isocyanates to be suspended (denominator) is advantageously greater than 1% and preferably greater than 2%.

The self-emulsifying nature that constitutes an advantage in these uses appears at and above a mass ratio of about 3% in the presence of an emulsifying compound of other types (which are themselves in an amount at least equal to 3%) and of about 5% when the compounds of formula (I) represent at least 90% by mass of all of the surfactants used as emulsifiers.

The coreagents used with the isocyanate according to the invention are often commercially available with their own surfactants, such that when the isocyanate composition of the invention is emulsified in the aqueous phase of the coreagent, self-emulsification may take place although the amount of surfactant of formula (I) is insufficient to ensure the self-emulsification in pure water according to the present invention. This compatibility with the surfactants used with polyols is of great interest for the implementation of the invention.

It is also desirable for the amount of said compound(s) of formula (I) to correspond to a value of between 10⁻² and 1 and advantageously between 5×10⁻² and 0.5 phosphorus atom per liter.

Thus, the mass ratio between, on the one hand, the compounds of formula (I) (numerator) and, on the other hand, the isocyanates to be suspended (denominator) is advantageously at least equal to 2% and preferably at least equal to 4%, and not more than about 15% and preferably not more than 10%, and this mass ratio is thus advantageously between about 2% and 15% and preferably between about 4% and 10% (2 significant figures); these intervals are closed, i.e. they include the limits).

According to the present invention, said compounds may be used alone or as a mixture with one or more surfactants.

These optional surfactants may also be chosen from other ionic compounds [especially alkyl sulfate(s) or phosphate(s), alkyl-phosphonates, -phosphinates or -sulfonates, fatty acid salt and/or zwitterionic salt] and, among the nonionic compounds, those blocked at the end of the chain or otherwise. However, nonionic compounds containing alcohol functions on at least one of the chains appear to have a slightly unfavorable effect on the (self)emulsification even though they have a favorable effect on other aspects of the composition; taking this into account, it is preferable for the content of this type of compound to represent not more than ⅓, advantageously not more than ⅕ and preferably not more than 1/10 by mass of said anionic compounds according to the invention.

The counter-cation(s) that ensures the electrical neutrality of the surfactant compounds (such as those of formula (I)) targeted by the present invention is advantageously monovalent and is chosen from mineral cations and organic cations that are advantageously nonnucleophilic and consequently of quaternary or tertiary nature [especially “oniums” of column V such as phosphoniums, ammoniums (including protonated amines), or even of column VI such as sulfonium, etc.] and mixtures thereof, usually ammoniums, generally derived from an amine, advantageously a tertiary amine.

Advantageously, it is avoided for the organic cation to have a reactive hydrogen with the isocyanate function. This explains the preference for tertiary amines.

The mineral cations may be sequestered with phase-transfer agents, for instance crown ethers.

The pKa in water of the cations derived from the protonation of the neutral bases (organic [ammonium, etc.] or mineral bases) is advantageously at least equal to 7, preferably to 8 and not more than 14, preferably not more than 12 and more preferentially not more than 10.

The cations and especially the amines corresponding to the ammoniums (protonated amines in this case) advantageously do not have any surfactant properties, but it is desirable for them to have good solubility, or in any case sufficient solubility to ensure the solubility of said compounds containing a functional group and a polyoxygenated chain, in aqueous phase and at the working concentration.

The tertiary amines and the quaternary ammoniums or phosphoniums containing not more than 16, advantageously 12, preferably not more than 10 and more preferentially not more than 8 carbon atoms per “onium” function (obviously including the ammoniums derived from a tertiary amine by protonation) are preferred; it is recalled that it is preferred for there to be only one function per molecule.

The tertiary amines and the quaternary ammoniums or phosphoniums containing at least 4, advantageously at least 5, preferably at least 6 and more preferentially at least 7 carbon atoms per “onium” function (obviously including the ammoniums derived from a tertiary amine by protonation) are preferred.

According to the foregoing text, it is seen that the preferred bases are tertiary monoamines, or even monophosphines, containing from 6 to 10 carbon atoms and advantageously 7 or 8 carbon atoms.

According to the present invention, it is preferable for one of the substituents on the nitrogen or on the phosphorus to be a secondary or even a tertiary radical, advantageously a 7-membered, at most, and advantageously a 5- or 6-membered cycloalkyl.

The amines may comprise other functions and especially functions corresponding to the functions of the amino acids and of the cyclic ether functions, for instance N-methylmorpholine, or otherwise. These other functions are advantageously in a form that does not react with the isocyanate functions and does not significantly impair the solubility in aqueous phase.

It is very desirable for the anionic compounds according to the present invention to be in a neutralized form such that the pH it induces during dissolution or placing in contact in water is at least equal to 3, advantageously to 4, preferably to 5 and not more than 12, advantageously not more than 11 and preferably not more than 10.

Thus, it is preferable for only the strong or medium-strength acid functions (i.e. those with a pKa of not more than 4) to be neutralized when there is more than one of them. The weak acidities, i.e. those with a pKa of at least 5, may be partially neutralized.

As has been mentioned previously in more general terms, it is preferable for the compounds in which “q” is zero to be in largely predominant amount. Thus, when the phosphorus is a phosphorus V (i.e. 2m+p+q=5) and when compounds of the mixture are esters, it is desirable to use mixtures of monoester(s) and of diester(s) in a monoester/diester molar ratio of greater than 2, advantageously greater than 3, preferably greater than 4 and more preferentially greater than 5, or even greater than 10.

The emulsifiers according to the invention, especially the above mixtures, may also comprise from 1% to about 20% (however, it is preferable for this not to exceed about 10%) by mass of phosphoric acid and/or phosphorous acid (which will advantageously be at least partially salified so as to be within the recommended pH zones) and from 0 to 5% of pyrophosphoric acid esters. Although, technically, the presence of phosphorous acid is possible, some of its derivatives are considered to be toxic and it is therefore advisable to avoid the use of this acid, especially in cases where there is a risk of forming derivatives considered to be toxic.

The composition may also comprise a catalyst, advantageously a latent catalyst (which may be released by the action of external agents, for example visible or UV radiation, or oxygen).

According to the present invention, it is possible to readily produce a stable emulsion and especially a stable oil-in-water emulsion.

Admittedly, it is possible to obtain a “water-in-oil” emulsion, but such an emulsion is not chemically stable. “Water-in-oil” emulsions promote a hazardous, since it is occasionally abrupt, decomposition of isocyanate functions. To avoid this problem, it is recommended to add the isocyanate composition according to the invention to the aqueous phase rather than the reverse.

The aqueous phases bearing the adhesive polymers often have an appreciable surfactant property. Thus, it is not uncommon for the emulsifiable isocyanate composition to be self-emulsifying in the aqueous phase bearing the adhesive polymer(s), whereas it is not self-emulsifying in pure water.

Thus, when the surfactant concentration is low, it may arise that there is demixing into two dispersions (in general emulsions): one “oil-in-water” sitting on the other, which is “water-in-oil”. As has been mentioned previously and will be developed hereinbelow, the latter dispersion is often chemically unstable, with release of carbon dioxide due to hydrolysis of the isocyanate function by the water. This situation may be overcome by means of more vigorous stirring or, better still, by increasing the emulsifier content.

The content of isocyanate composition in the final dispersion ranges from 1% to about 20%, advantageously from 2% to 15% and preferably from 3% to 10% (closed intervals, i.e. including the limits).

It is desirable for the isocyanate composition according to the invention, after dispersing or emulsifying in an aqueous phase, to have a water content of not more than 95%, advantageously not more than 90% and preferably not more than 85%, and at least 25%, advantageously at least 30% and preferably at least 35%. It is thus possible to obtain emulsions that are rich in solids.

The ready-to-use dispersion comprises, besides the aqueous phase and the isocyanate phase dispersed in said aqueous phase, polymers or oligomers bearing a function containing a labile hydrogen. The invention is particularly suitable for polyurethanes bearing a function containing a labile hydrogen and for polyacrylic alcohols. During the use of the compositions according to the present invention to potentiate adhesion and then adherence, the contents of function(s) containing a labile hydrogen (i.e. a function that is reactive with the isocyanate function) is generally low (more specifically, per 100 g of solids ranging from 5 milliequivalents to 90 milliequivalents, advantageously from 10 to 60 and preferably from 20 to 50 milliequivalents of function(s) containing a labile hydrogen, advantageously alcohol); for the other types of coating (paints and varnishes), the content is higher since it generally ranges from 10 milliequivalents per 100 g to 400 milliequivalents per 100 g, advantageously from 20 to 300 and preferably from 30 to 200 milliequivalents per 100 g of solids, and more preferentially from 50 to 150. The functionality (calculated from Mₙ) generally ranges from 3 to 12 and usually from 5 to 10. The molecular mass Mₙ generally ranges from 1000 to 10 000 and advantageously from 2000 to 6000.

The description of a polyol that is particularly suitable for paint and/or varnish according to the present invention may be given:

When a polyol of acrylic nature is used, it is preferable for it to satisfy the following conditions for a dry extract (DE) of between 75% and 80% by weight:
Mw (weight-average molecular weight) not greater than 10 000 and advantageously not greater than 5000.

An Mw of less than 10 000 and advantageously less than 5000 is preferred.

Mw is advantageously at least equal to 800 and preferably to 1500.
Mn (number-average molecular weight) is 5000 and advantageously not more than 3000.

An Mn of less than 5000 and advantageously less than 3000 is preferred.
Mw/Mn (dispersity ratio) not greater than 5, advantageously not greater than 3 and preferably not greater than 2.

An Mw/Mn of less than 5, advantageously less than 3 and preferably less than 2 is preferred. This ratio is generally at least equal to 1.

For further details, reference may be made to standard ASTM-E222.

The Mn and Mw values are advantageously obtained by gel permeation exclusion chromatography using styrene as standard.

Polyols obtained by polymerization of hydroxyalkyl(meth)acrylates, especially hydroxyethyl(meth)acrylate and hydroxypropyl(meth)acrylates, are preferred.

For paints and varnishes on wood, polyurethane or acrylic polyols with an alcohol function (mass of 17) content of from 0.1% to 4% by mass, preferably ranging from 0.5% to 3%, and a molecular mass Mn at least equal to 2000, preferably to 3000 and advantageously not more than 10 000, are used.

The solvent content advantageously represents not more than 20% by mass, preferably not more than 10%, more preferentially not more than 5% and even less than 1% of the final dispersion (i.e. the dispersion ready to use for bonding).

The paint and especially the varnish emulsions according to the present invention have significantly improved properties as regards the quality of the coating: noteworthy adhesion, improved resistance to polar solvent and to acids, enhanced resistance to stains of food origin (mustard, coffee), the cleaning of which is one of the most laborious and difficult of household tasks.

According to one particularly advantageous embodiment of the present invention, after dispersing or emulsifying the isocyanate composition, the sum of the constituents of the binder (i.e. the mass contents of the isocyanate(s), emulsifiers and polymer(s) (advantageously containing function(s) bearing reactive hydrogen with the isocyanate functions, especially polyols]) in water ranges from 20% and preferably from 30% to 60% and preferably to 50% relative to the total amount of the composition.

In particular, the solids content may reach values at least equal to 40%, and even equal to 50%, or even 60%, but is generally les than 80%.

To return to the problem of emulsification, during the study that led to the present invention, in particular in the case of aliphatic isocyanates (i.e. isocyanates linked to the hydrocarbon-based skeleton (i.e. containing both hydrogen and carbon) via a saturated (sp³) carbon)), it has been shown that there was a risk of runaway of various reactions when certain water proportions were reached. Thus, it is recommended to avoid compositions in which the mass ratio between, on the one hand, the amount of water in the aqueous phase and, on the other hand, the sum of the isocyanate and of the surfactant according to the invention is between 10⁻² and ⅕ (0.5). If greater safety is desired, ratios of between 10⁻³ and 1 will be avoided. To prevent any entry into this hazardous zone, it is recommended to prepare the emulsion by adding the emulsifiable isocyanate composition to the aqueous phase rather than the reverse.

It is preferable to use isocyanate compositions with a viscosity of not more than 1500 mPa·s, advantageously not more than 1200 mPa·s and preferably 1000 mPa·s.

In the course of the study that led to the present invention, it was shown that the size (the granulometry) of the emulsions played a major role in the quality of the final adherence. More particularly, the polydispersity of the emulsion of the isocyanate composition when said composition is alone and when it is with the adhesive polymer is important.

Thus, it is preferable that, in the case of the isocyanate alone, the particle size d₅₀ should be not more than 25 and preferably not more than 22 μ, for a polydispersity index of not more than 1.5, advantageously not more than 1.3 and preferably not more than 1.1.

When the isocyanate (or more precisely the emulsifiable isocyanate composition) is dispersed in the phase of the polymer, monodispersity is more difficult to achieve, but the results of the compounds according to the invention constitute significant progress.

The isocyanates targeted by the invention especially include the compounds detailed below.

These compounds may advantageously contain the structures known in this field, for example “prepolymers” derived from the condensation of polyol (for example trimethylolpropane) in general triol (advantageously primary) and especially the most common, i.e. oligomers such as those containing isocyanurate units (also known as trimer), those containing a uretidinedione structure (also known as dimer), biuret or allophanate structures or a combination of structures of this type on a single molecule or as a mixture.

If it is desired to substantially lower the solvent content of the composition, especially when it is in emulsion form, it is preferable to use mixtures of this type that are naturally (i.e. without addition of solvent) of low viscosity.

Compounds having this property are especially the derivatives (such as isocyanurate, also known as trimer, uretidinedione structures, also known as dimer, biuret or allophanate structures or a combination of structures of this type on a single molecule or as a mixture) partially and/or totally of aliphatic isocyanates whose isocyanate functions are linked to the skeleton via ethylene fragments (for example polymethylene diisocyanates, especially hexamethylene diisocyanate and those of arylenedialkylene diisocyanates whose isocyanate function is at least two carbons remote from the aromatic nuclei, such as (OCN—[CH₂]ₜ-Φ-[CH₂]ᵤ—NCO) with t and u greater than 1).

Thus, isocyanate compositions a) which comprise at least 50% and advantageously 70% by mass of oligomers chosen from hetero- or homooligomers, at least one of the monomers of which is an aliphatic monomer, and advantageously all of the monomers of which are aliphatic monomers chosen from those bearing at least two isocyanate functions and of which the skeleton, on the shortest trajectory connecting two isocyanate functions, comprises at least one polymethylene sequence of at least two methylene chain units (CH₂)π(π≧22), which is exocyclic when the monomer comprises a ring, are advantageously used.

Oligomers that are considered include compounds with a mass of not more than about 1600, i.e., for hexamethylene diisocyanate, not more than about ten diamine units that are precursors of isocyanate functions. In said polymethylene chain of at least two methylene chain units (CH₂)_{π}, π represents an integer from 2 to 10 and advantageously from 4 to 8. Said oligomers are advantageously chosen from hexamethylene diisocyanate homooligomers.

These compounds or mixtures advantageously have a viscosity of not more than about 2000 centipoises (or milliPascal·seconds) and preferably not more than about 1500 centipoises (or millipascal·seconds).

When these values are not reached, it is then often useful to bring the mixture to these viscosity values by adding a minimum amount of suitable solvent(s). When reactive solvents are not used (see below), it is, however, preferable for the amount of solvent in the isocyanate composition not to exceed 20% and advantageously 10% by mass of the emulsifiable isocyanate composition.

When this is compatible with the application, the solvents that are the most suitable are those that may conveniently be referred to as reactive solvents (since they have these two characteristics).

Reactive solvents that may be mentioned include aliphatic di- and triisocyante, or even tetraisocyanate, monomers with a molecular mass of at least 200 (2 significant figures) and advantageously at least 250, and with a viscosity of not more than 500 mPa·s. Among the solvents of this type that may be mentioned are those derived from esters of diamino acids, such as lysine and ornithine, and especially LDI (lysine diisocyanate, derived from lysine ester), LTI (lysine triisocyanate, derived from the ester of lysine with ethanolamine) and trisubstituted alkanes such as NTI (nonyl triisocyanate OCN—(CH₂)₄—CH(CH₂—NCO)—(CH₂)₃—NCO) and UTI (undecyl triisocyanate OCN—(CH₂)₅—CH(—NCO)—(CH₂)₅—NCO). Although not developed on an industrial scale, tetraisocyanates derived from double esters of diols [such as glycols, propanediols (especially 1,3-propanediol), butanediols (especially 1,4-butanediol) and pentanediols (especially 1,5-pentanediol)] and of diamino acids, give good results.

As reactive solvents, mention may also be made of polymethylene diisocyanate dimers optionally substituted on a methylene with an ethyl or a methyl (containing a uretidinedione ring), bis-dimers (trimers containing two uretidinedione rings) and their mixtures with each other and, where appropriate, with the tris-dimers (tetramer containing three uretidinedione rings). Such mixtures may be made by heating the monomers (see the international patent application published under No. WO 99/07765).

As reactive solvents, mention may also be made of monoallophanates of polymethylene diisocyanate optionally substituted on a methylene with an ethyl or a methyl (dicondensate with a monoalcohol), the two kinds of bis-allophanates (tetracondensate with a diol or, preferably, tricondensate with two monoalcohols containing two allophanate functions), and mixtures of two of the three specified species. For the synthesis of this type of product, reference may be made to the international patent application published under No. WO 99/55756.

Needless to say, mixtures of the various types of reactive solvent above may be used.

In other words, the viscosity of the isocyanate composition can be adjusted before mixing with the emulsifier to a value of not more than about 2500 centipoises (or mPa·s, i.e. milliPascal—seconds), advantageously not more than 2000 mPa·s, preferably not more than about 1500 centipoises (or milliPascal·seconds), more preferentially 1200 and even more preferentially 1000 mPa·s, by adding at least one of the above compounds; i.e. by cutting with an isocyanate composition with a viscosity of not more than 1200 mPa·s and less than the desired viscosity (i.e., respectively, 3000, 2000, 1500 and 1000 mPa·s), advantageously chosen from:
those comprising at least 10% by mass of at least one aliphatic di- and polyisocyanate monomer with a molecular mass of greater than 200 and advantageously greater than 250, and a viscosity of not more than 500 mPa·s;
those comprising at least 10% by mass of at least one derivative containing a uretidinedione ring chosen from polymethylene diisocyanate dimers and bis-dimers optionally substituted on a methylene with an ethyl or a methyl, with a viscosity of not more than 500 mPa·s;
those comprising at least 10% by mass of at least one allophanate chosen from polymethylene diisocyanate monoallophanates optionally substituted on a methylene with an ethyl or a methyl, and with a viscosity of not more than 500 mPa·s;
those formed by the mixture of the above three types of composition, with a viscosity of not more than 500 mPa·s.

As already mentioned above, the isocyanates concerned may be mono-, di- or even polyisocyanates. Advantageously, these derivatives may contain structures of isocyanurate type, also known as trimers, uretidinedione structures, also known as dimers, biuret or allophanate structures or a combination of structures of this type on a single molecule or as a mixture. It should be pointed out that the trifunctional monomers such as LTI (lysine triisocyanate) and NTI (nonyl triisocyanate) are used predominantly in unmodified form, but may be oligomerized.

The isocyanate monomers are generally derived from diamines converted into diiocyanates by carbonation; this operation is performed in the vast majority of cases by the action of phosgene or equivalent reagents; the diamine units are found, quite obviously, in the compounds derived from oligocondensation (for example dimers, trimers, allophanates, urethanes, ureas and biuret, etc.). These monomers may especially be:
aliphatics, including cycloaliphatic and aryl-aliphatic monomers, examples being:
   simple aliphatic monomers, such as polymethylene diisocyanate monomers containing polymethylene sequences (CH₂)_{π}π in which ππ represents an integer from 2 to 10 and advantageously from 4 to 8, and especially hexamethylene diisocyanate, one of the methylenes possibly being substituted with a methyl or ethyl radical, as is the case for MPDI (methyl pentamethylene diisocyanate);
   partially “neopentyl” aliphatic partially cyclic (cycloaliphatic) monomers, such as isophorone diisocyanate (IPDI);
   cyclic aliphatic (cycloaliphatic) diisocyanate monomers, such as those derived from norbornane;
   arylene dialkylene diisocyanates (such as OCN—CH₂-Φ-CH₂—NCO, a portion of which does not show any essential difference from aliphatics, i.e. those in which the isocyanate function is at least two carbons remote from the aromatic nuclei, such as (OCN—[CH₂]ₜ-Φ-[CH₂]ᵤ—NCO) with t and u greater than 1;
or alternatively aromatics such as tolylene diisocyanate (however, aromatic isocyanates function poorly as regards aqueous emulsification).

The term “aliphatic isocyanate function” means an isocyanate function borne by a carbon of sp³ hybridization.

The preferred polyisocyanates targeted by the technique of the invention are those in which at least one, advantageously two and preferably three of the conditions below are satisfied:
at least one, advantageously at least two and more preferably all of the NCO functions are linked to a hydrocarbon-based skeleton via a saturated (sp³) carbon, preferably with at least one and more preferentially at least two of the subconditions below:
   at least one and advantageously two of said saturated (sp³) carbons bears at least one and advantageously two hydrogen(s) (in other words, it has been found that better results were obtained when the carbon bearing the isocyanate function bore a hydrogen and preferably two hydrogens);
   at least one and advantageously two of said saturated (sp³) carbons themselves bear a carbon, which is advantageously aliphatic (i.e. of sp³ hybridization), itself bearing at least one and advantageously two hydrogen(s); in other words, it has been found that better results were obtained when the carbon bearing the isocyanate function was not in a “neopentyl” position:
all the carbons via which the isocyanate functions are linked to the hydrocarbon-based skeleton are saturated (sp³) carbons, which advantageously partially and preferably totally bear a hydrogen and preferably two hydrogens; in addition, it is advantageous for said saturated (sp³) carbons to be at least partially (advantageously ⅓ and preferably ⅔), and preferably totally borne themselves by a carbon, which is advantageously aliphatic (i.e. of sp³ hybridization), itself bearing at least one and advantageously two hydrogen(s); in other words, it has been found that better results were obtained when the carbon bearing the isocyanate function was not in a “neopentyl” position;
those at least partially having an isocyanuric or biuret skeleton (whether this skeleton is derived from only one or from several monomers, see below) and more specifically structures of isocyanurate type, also known as trimers, uretidinedione structures, also known as dimers, biuret or allophanate structures or a combination of structures of this type on a single molecule or as a mixture, are particularly suitable.

When the polyisocyanates are relatively heavy, i.e. when they comprise at least four isocyanate functions, usually from 4 to 6, the first two conditions become:
at least ⅓ and advantageously ⅔ (preferably all) of the NCO functions are linked to a hydrocarbon-based skeleton via a saturated (sp³) carbon;
at least ⅓ and advantageously ⅔ and preferably all of said saturated (sp³) carbons bears at least one and advantageously two hydrogen(s); in other words, it has been found that better results were obtained when the carbon bearing the isocyanate function bore a hydrogen and preferably two hydrogens; in addition, it is advantageous for said saturated (sp³) carbons to be at least partially (advantageously ⅓ and preferably ⅔) and preferably totally borne themselves by a carbon, which is advantageously aliphatic (i.e. of sp³ hybridization), which itself bears at least one and advantageously two hydrogen(s); in other words, it has been found that better results were obtained when the carbon bearing the isocyanate function was not in a “neopentyl” position.

The isocyanates, especially aliphatic isocyanates, may react with some of the anionic compounds targeted by the invention to form anhydrides; these anhydrides are capable of regenerating the compounds of formula (I) and in certain cases react like masked isocyanates; the reactions for forming these anhydrides, which may moreover be inhibited by total neutralization of the acid functions with a strong base, are of two types:
either elimination of a molecule of water between two anionic functional groups and thus form a function of the type E-O-E (i.e. a pyrophosphoric sequence in the case of phosphates);
or addition of the hydroxyl of non-neutralized or poorly neutralized acid functions, to the NCO function to form a function having the sequence —NH—CO—O-E. These compounds (mixed anhydrides between a carbamic acid and the anionic functional group) are also targeted by the present invention.

The first case corresponds to the case in which the first acidity has been imperfectly neutralized. These products also have excellent surfactant properties.

In the course of the research that led to the present invention, it was possible to show that the presence of molecules (corresponding to the concept of reactive solvent) of low molecular weight [i.e. not more than 700 (2 significant figures), advantageously 600 (2 significant figures) and preferably 500 (2 significant figures)], containing neither a hexacyclic structure, nor a biuret function or even a urethane structure, could be correlated with good adherence. Such molecules are molecules containing not more than three diamine units and are essentially chosen from dimers, bis-dimers, polymethylene diisocyanate monoallophanates and trifunctional monomers of the type LTI and NTI.

Thus, advantageously, at least one of these molecules is present in the isocyanate composition a). In total, these low molecular weight molecules represent a portion ranging from 5% to 25% and advantageously from 7% to 15% by mass of the isocyanate composition a).

The dimers and bis-dimers are preferred and represent by mass advantageously from 5% to 20%-and preferably at least 7% of the composition a).

The amount of solvent in the isocyanate composition advantageously represents not more than 20% by mass of the isocyanate composition a), preferably not more than 10% and more preferably not more than 1%.

It is preferable, for reasons of work law, for the amount of volatile monomer of the hexamethylene diisocyanate type to be not more than 1% by mass, advantageously not more than 0.5%, preferably not more than 0.2% and more preferentially not more than 0.1% by mass of the isocyanate composition a).

The nonlimiting examples that follow illustrate the invention.

Starting materials:

Emulsifiable Composition According to the Present Invention

The emulsifiable isocyanate composition according to the present invention was prepared by adding a surfactant (or emulsifier) of statistical formula (I) to an isocyanate composition prepared from trimerized hexamethylene diisocyanate with a viscosity of less than 1200 mPa·s and comprising, by mass:

8% (±1%) of true dimer;

2% (±1%) of bis-dimer;

2% (±1%) of biuret;

55% (±2%) of true trimer.

The emulsifier used is of statistical formula (I) in which
q represents 0.45;
s and r represent 5;
p=1.55;
R₁ and R₂ are isotridecyl radicals;
with, in addition, as impurity, 5 mol % of nonionic phosphorus (corresponding triester) and 3±2 mol % of phosphoric acid.

The amine used for the neutralization is N,N-dimethyl-cyclohexylamine.

Phosphoric acid represents 3±2 mol % of the phosphorus present (in other words, the phosphorus of the phosphoric acid represents 3±2 mol % of the total amount of phosphorus present).

Only the first acidity of the phosphorus acids present was neutralized.

After addition, the emulsifiable isocyanate composition comprises 7.5% (±1%) by mass of true dimer (i.e. only one uretidinedione unit and two diamine units) and 3.5% by mass of compound of formula (I). It has a viscosity of 1400 mPa·s (NCO=21.7%)

The Compound Desmodur® DN

This is a commercial composition comprising a high content (at least 70%) of true trimer (i.e. an isocyanurate ring and three diamine units) and which also comprises a neutral surfactant derived from the condensation between isocyanate oligomers and a diol that is a copolymer of ethylene oxide (46%) and propylene oxide (54%). The viscosity is 1250 mPa·s (NCO=21.8%).

This composition is well known for giving good results.

The HDT-Based Composition (Product of Trimerization of Hexamethylene Diisocyanate

The HDT tested is the common product derived from trimerization with less than 2% of dimer, at a viscosity of 2700 mPa·s, to which is added 11% of the product of formula (I) specified above.

This composition is self-emulsifying.

Final viscosity: 4300 mPa·s

NCO=19%

Percentage of surfactant after addition=10%

Spatula Test

The spatula test is a qualitative test in which the test compound is taken up from the container using the flat part of a spatula and is stirred in water for 2 minutes. If there is still product visible at the end of the spatula, the test is negative. This common test is a good indicator of the ease of use.

All the tests are performed with an isocyanate composition content of 4% by mass.

The particle size measurements are performed using a Horiba LA 910 machine.

### EXAMPLE 1

### Emulsification with Comparative Data

| | | Isocyanate | | Dispercoll U54 | | Mixture | |
|---|---|---|---|---|---|---|---|
| | Spatula | median | (d₁₀ − d₉₀)/ | | (d₁₀ − d₉₀)/ | | (d₁₀ − d₉₀)/ |
| Test product | test | d₅₀ | d₅₀ | d₅₀ | d₅₀ | D₅₀ | d₅₀ |
| Invention | + | 21μ | 0 | 166 nm | 0.48 | 2.7μ | 16 |
| Desmodur DN | + | 19μ | 1.6 | | | bipopulous | 92 |
| | | | | | | 22μ | |
| | | | | | | (19%) + 215 nm | |
| HDT trimer | − | 0.09μ | 0.845 | | | bipopulous | 0.55 |
| usual | | | | | | 14μ | |
| viscosity | | | | | | (8%) + 250 nm | |
| 2700 mPa · s | | | | | | | |

### EXAMPLE 2

### Bonding of Elastomer (Sports Shoes)—Comparative Study of a Composition According to the Present Invention with Usual Isocyanate Compositions

The polymer used is Dispercoll® U54 (see technical notice dated Monday Jan. 31 2000). It is a polyurethane dispersion containing 50% dry polymer.

Test Composition:

Coreagent

| | |
|---|---|
| Dispercoll U54 | 100.00 g |
| Tafigel PUR 40 (see notice of February 1998) | 0.47 g |
| Isocyanate phase: | |
| Test product | 3.00 g |

Test of Use for Adhesive

The tests are performed according to DIN standard EN 1392, and the samples are dried for 4 days at room temperature (23° C.). The breaking strengths are measured according to standard DIN 205/91.

Namely:
curing conditions for the shear, peel and tensile tests: 4 days at room temperature;

curing conditions for the tests in a humid environment: 4 days at room temperature; 6 hours in water and one hour of drying followed by the peel test.

| | Peel: on dry CPU | Peel: on NBR |
|---|---|---|
| Test product | DIN ENM1392 | dry medium |
| U 54 alone | 0.56 | 0.18 |
| With the invention | 1.06 | 0.73 |
| With Desmodur ® DN | 1 | 0.67 |
| With HDT without surfactant | 1.1 | 0.55 |
| With HDT with surfactant | 1.06 | 0.73 |

| | Peel on C-PUNBR | | Peel on NBRC-PU | |
|---|---|---|---|---|
| | wet | | wet | |
| Test product | before | after soaking | before | after soaking |
| U 54 alone | | | | |
| With the invention | 1.06 | 0.98 | 0.73 | 0.68 |
| With Desmodur ® DN | 1 | 0.64 | 0.67 | 0.47 |
| With HDT with | 1.06 | 0.67 | 0.73 | 0.5 |
| surfactant | | | | |

### EXAMPLE 3

### Test of Paint (Varnish) on Wood

The compound according to the present invention was mixed (emulsified) in a 7.5/100 ratio with the following coreagent mixture:

| | |
|---|---|
| Alberdingk U 915 (see technical | 71 |
| notice of October 1998) | |
| BYK 024 | 0.4 |
| Dowanol DPM | 2.4 |
| Dowanol DPNB | 2.4 |
| Deionized water | 19 |
| Drew Plus T 4202 | 1.1 |
| DSX 2000 | 1 |
| Additive (wetting agent) | 0.7 |
| Lubaprint VP 682 | 2.00 |
| Total | 100.00 |

The properties of this coreagent are indicated below:

| | |
|---|---|
| Solids (%) | 28.39 |
| Viscosity DIN 4 (s) | 21 |
| pH | 8.3 |
| PU thickener PU (solid) | 0.4 |

The varnish (thickness of 200 μm) was applied to a typical parquet and then dried. The König hardness reaches, after drying (at least three days), a steady value of 90 s⁻¹; this value is similar to that of the standard used (commercial high-quality product, used in a form dissolved in a solvent and then emulsified).

| | | | | Hardener |
|---|---|---|---|---|
| | | | Standard | according to |
| Varnish attacking agent | Time | | hardener | the invention |
| Acetic acid | 1 | h | 4.5 | 5 |
| 48 vol % ethanol | 5 | h | 5 | 5 |
| Palatinol C (DBP) | 16 | h | 5 | 5 |
| Cream | 16 | h | 5 | 5 |
| Water | 16 | h | 5 | 5 |
| Milk | 16 | h | 5 | 5 |
| Red wine | 16 | h | 5 | 5 |
| Coffee | 16 | h | 3 | 4 |
| Mustard | 16 | h | 3 | 4 |
| Oil-free ink | 16 | h | 3 | 3 |
| Acetone | 10 | s | 4.5 | 5 |
| Ammonia (10% in water) | 10 | min | 5 | 5 |

Rating of the Degradation

5: absence of mark;

4: slight change in gloss or shade, but detectable only using light reflected onto the surface of the coating, or else very faint mark;
3: faint mark detectable at various viewing angles;
2: pronounced mark without changing the structure of the surface of the coating;
1: strong mark with, where appropriate, a change or destructuring of the surface structure of the coating, or else the filter paper is attached to the surface.

1-14. (canceled)

15. A composition comprising, for successive or simultaneous addition: an isocyanate composition (a) with a mass content of N═C═O function of between 10% and 30%, optionally from 15% to 25% and with a viscosity of not more than 2500 mPa·s, optionally not more than 1500 mPas, and
a surfactant (b) comprising a compound or a mixture of compounds of mean general formula: 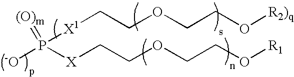
wherein:
p represents a value between 1 and 2;
m represents zero or 1;
the sum p+m+q is equal to 3;
the sum 1+p+2m+q is equal to 3 or 5, optionally 5;
X is an oxygen;
X′ is an oxygen;
n and s have the same statistical value, chosen between 5 and 30, optionally between 9 and 20 wherein R₁ and R₂, which are different oridentical, are alkyls, optionally substituted.

16. The composition as claimed in claim 15, wherein the viscosity is not not more than 1200 mPa·s.

17. The composition as claimed in claim 15, wherein the mass of the agent b) (numerator) and the mass of the composition a) (denominator) has a ratio ranging from 2% to 10%, optionally from 3% to 7%.

18. The composition as claimed in claim 15, wherein the sum p+q is equal to 2.

19. The composition as claimed in claim 15, wherein said isocyanate composition a) comprises at least 50%, optionally 70% by mass of oligomers chosen from hetero- and homooligomers, at least one of the monomers of which is an aliphatic monomer bearing at least two isocyanate functions and whose skeleton, on the shortest trajectory connecting two isocyanate functions, comprises at least one polymethylene sequence of at least two methylene chain units (CH₂)_{π}(π≧2), which is exocyclic when the monomer comprises a ring.

20. The composition as claimed in claim 15, wherein said isocyanate composition a) further comprises a portion of reactive solvent comprising at least one molecule chosen from dimers, bis-dimers, monoallophanates, polymethylene diisocyanates and di-, tri- or tetrafunctional monomers with a molecular mass at least equal to 200.

21. The composition as claimed in claim 20, wherein said portion represents a portion ranging from 5% to 20% by mass of the isocyanate composition a).

22. The composition as claimed in claim 20, wherein the dimers and the bis-dimers represent by mass from 5% to 20% of the composition a).

23. The composition as claimed in claim 15, further comprising an aqueous phase constituting the continuous phase of an emulsion of said composition.

24. The composition as claimed in claim 23, further comprising a polymer bearing a function containing a labile hydrogen, in the form of a solution or a dispersion in the aqueous phase.

25. The composition as claimed in claim 24, further comprising a pigment.

26. A coating a composition, comprising a composition as defined in claim 15, and an aqueous phase with a pH of between 4 and 9.

27. The coating as claimed in claim 26, being an adhesive.

28. The coating as claimed in claim 26, being a paint or a varnish.
